(19) United States
(12) Patent Application Publication
(10) Pub. No.: US 2004/0049422 A1
(43) Pub. Date: Mar. 11, 2004

(54) Systems and methods for providing pre-point-of-sale incentive marketing

(76) Inventor: Lawrence Mortimer, Castle Rock, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/329,289

(22) Filed: Dec. 24, 2002

Related U.S. Application Data
(60) Provisional application No. 60/382,507, filed on May 21, 2002.

(51) Int. Cl. G06F 17/60

(52) U.S. Cl. 705/14

(57) ABSTRACT

A system and method for printing coupons at various specialty departments within a retail store at the time a product selection is made, but prior to the point-of-sale. The coupons preferably provide incentives for complementary goods based upon the selected product, and may also take into account shopping history or other factors relevant to a particular consumer. The coupons are provided on a rotating basis in preferred examples so that particular coupons are selected from a pool of available incentives, but each purchase instance may result in a different set of coupons being attached to the product.

### CROSS-REFERENCE TO RELATED APPLICATION

This application claims the benefit of U.S. Provisional Application No. 60/382,507, filed May 21, 2002, the disclosure of which is incorporated herein by reference.

### BACKGROUND OF THE INVENTION

1. Field of the Invention

The present invention relates, in general, to coupons and other retail sales incentives, and, more particularly, to software, systems and methods for providing pre-point-of-sale incentives in retail grocery stores, preferably occurring at or near the point of product selection by a consumer.

2. Relevant Background

Manufacturers and retailers use a variety of incentive mechanisms to motivate consumer shopping and purchasing behavior. Shopping behavior refers generally to the selection of one retail store over another, whereas purchasing behavior refers to the selection of particular products to purchase irrespective of the retail store. Historically, these incentives take the form of discounts or coupons that encourage store or brand loyalty, test price points, or simply encourage a consumer to purchase a particular product.

Given the expense of incentive systems to manufacturers and retailers, it remains a continuing problem to improve efficiency. Coupon distribution has a significant impact on efficiency. Coupon distribution will affect who receives a coupon, how the coupon is received, and when the coupon is received. Any or all of these factors may affect the consumers ability or willingness to redeem the coupon. Untargeted coupons distributed through newspapers and magazines, for example, generally have a very low redemption rate. Most people are familiar with receiving coupons for products they do not use, often at inconvenient times. Direct mail coupons offer the potential of targeting based on demographics, or upon consumer-specific shopping history. These targeted methods have higher redemption rates, but remain relatively inefficient.

Recently, point-of-sale (POS) coupons have been introduced. POS coupon systems enable a retailer to print coupons that are specifically relevant to a particular consumer based on items purchased during a particular transaction, and/or based upon shopping history. These coupons are intended to provide and incentive for the consumer to return to the issuing store at some time in the future. The coupons can be based on products purchased to either improve brand loyalty, or to encourage the consumer to try a competing product (e.g., house brands). Moreover, POS coupons may encourage purchase of other goods or services offered by the retailer such as pharmacy, photo processing, or video rental.

Commercially available printers may be used for generating coupons at a point-of-sale, such as disclosed in U.S. Pat. No. 4,723,212 issued on Feb. 2, 1988 and entitled Method and Apparatus for Dispensing Discount Coupons or as further disclosed in U.S. Pat. No. 4,910,672 issued Mar. 20, 1990 and entitled Method and Apparatus for Dispensing Discount Coupons. As disclosed in these patents, systems may be provided to generate coupons at the point-of-sale based upon the type of product purchase. In the disclosures of the above-captioned two patents, a coupon relating to a particular type of a product is generated based upon a bar code reader determining that a triggering or competing product has just been purchased by the consumer.

In spite of the high level of control promised by POS coupon systems, they provide their incentive after a sale is complete. In many cases, an incentive to buy brand Y next time has little effect when the consumer just purchased brand X . . . it may be weeks or months until the product must be purchased again. Even when the incentives relate to products not purchased, it is unlikely that the consumer will re-enter the store immediately to take advantage of the incentive. Hence, the consumer is likely to misplace, discard, or simply forget about the coupon before it can be redeemed.

An alternative coupon distribution method is to attach coupons to products themselves either as instantly redeemable coupons or for redemption upon a subsequent purchase. Such coupons can be for the product to which they are attached (e.g., a box of cereal), or for complementary products (e.g., a coupon for milk attached to a box of cereal). In addition to manufacture coupons, specialty areas of grocery stores such as meat, fish, deli, pharmacy and similar departments may use attached coupons to provide various incentives as well. For example, a bakery department may attach a discount coupon to some packages in order to encourage sales of day old bread. However, such coupons are not specifically relevant to the purchasing consumer as they are printed and attached to products in advance of a consumer purchasing decision. Moreover, the preprinted coupons cannot flexibly cross-sell a variety of other products or services within the store.

Hence, a need exists for a system and method that provides retail incentives before the point-of-sale, while retaining an ability to make the incentive specifically relevant to a particular consumer or particular purchase.

### SUMMARY OF THE INVENTION

Briefly stated, the present invention provides a system and method for providing coupons at various specialty departments within a retail store at the time a product selection is made, but prior to the point-of-sale. The coupons may be pre-printed on, for example, a label tape used to mark the product with price information, or, alternatively, printed dynamically in response to the selected product. The coupons preferably provide incentives for complementary goods based upon the selected product, and may also take into account shopping history or other factors relevant to a particular consumer. The coupons are provided on a rotating basis in preferred examples so that particular coupons are selected from a pool of available incentives, but each purchase instance may result in a different set of coupons being attached to the product.

### BRIEF DESCRIPTION OF THE DRAWINGS

FIG. 1 shows a networked retail environment in which the present invention is implemented; and

FIG. 2 shows example label coupons in accordance with the present invention.

### DETAILED DESCRIPTION OF THE PREFERRED EMBODIMENTS

The present invention is directed to a coupon system implemented in a retail grocery store having one or more specialty departments. In these specialty departments, a consumer selects goods and interacts with the retailer before the point-of-sale. During this interaction, a label of some kind is often printed to identify the product and pricing. The present invention leverages this installed system of label printing to provide incentive coupons at the point of product selection. These “label coupons” can be used to direct consumer purchases during the immediate shopping session, rather than requiring a subsequent trip back to the store.

These label coupons are readily used to provide incentives to purchase complementary goods and/or services. For example, when a consumer selects a cut meat from the meat department, a coupon for complementary sauces, vegetables, or other products can be printed. The value of the coupon can be readily adjusted based on the value of the meat (or other product) selected. In another example, a consumer may select a number of picnic type items from the deli department which could produce a coupon for discounted film or photo processing. It is contemplated that the pre-point-of-sale incentive system of the present invention can be implemented with great flexibility and provides advantages that both complement and replace some of the advantages of prior coupon systems.

The preferred implementations involve dynamic coupons, where the coupon identifies a qualifying product and/or a discount amount in response to the customer-selected product identified by the label to which the coupon is attached. This allows the coupons to be product-specific in that coupons for “turkey” at a deli department can be different than coupons for “roast beef”. However, it is contemplated that pre-printed coupons may also be provided. Pre-printed coupons can be department-specific rather than product-specific. For example, pre-printed coupons at a fish counter may be different than pre-printed coupons at a deli counter. In either case, incentives are provided to a customer based upon customer product selection, and are provided before the point-of-sale.

Although the particular examples provided herein are directed to retail grocery stores with conventionally-defined specialty departments, it should be understood that the invention is broadly applicable to other environments. For example, department stores may provide an opportunity for label couponing as products are selected in one department to provide incentives to use other departments. Also, specialty departments may be flexibly defined to include any product selection point where it is practical for the retailer to print a label with appropriate incentives in accordance with the present invention prior to the point-of-sale.

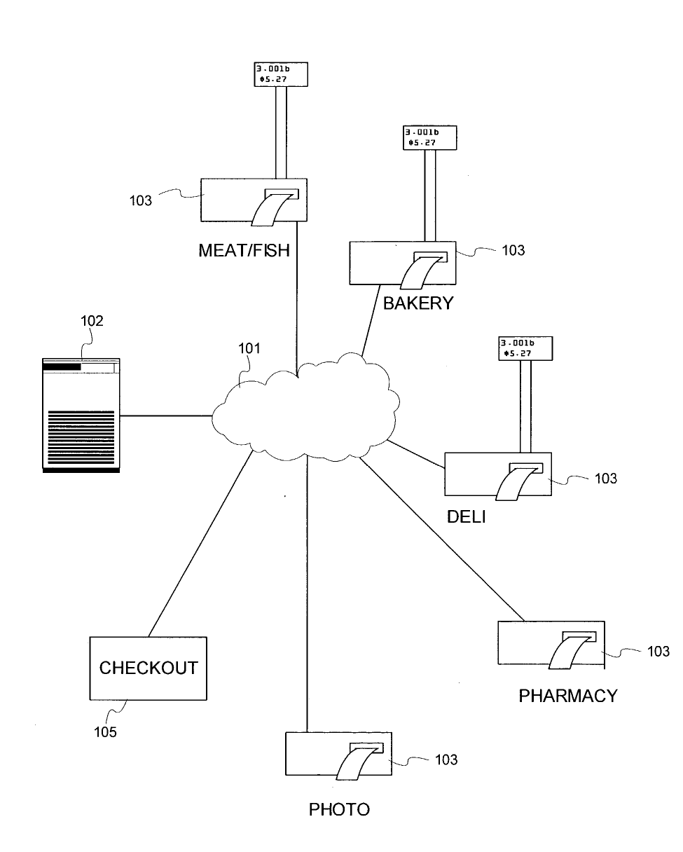

FIG. 1 shows an exemplary retail environment having a number of specialty departments. Each specialty department is represented by one or more terminals 103 that include label printing devices, often integrated with a scale or other department-specific mechanism. For example, the deli department typically has a scale and label printer. A pharmacy department has printers for prescription labels and drug information sheets that are specific to the particular transaction. These systems may be stand-alone, or may be coupled to one or more centralized data possessing systems such as server 102 through an in-store network 101. Network 101 may comprise a local area network (LAN) or wide area network (WAN) of any topology, and may be entirely private or involve public communication channels such as the Internet. All or part of network 101 may be implemented by wireless links.

In each specialty department 103, a customer selects products and/or services that are provided by the retailer. For example, a meat department will provide a customer-selected quantity of a customer-selected product. In a deli department, a wide variety of goods may be selected. Significantly, these customer selections are made before the customer reaches checkout 105. Hence, after the product selection the customer remains in the store to continue shopping.

The present invention is readily adapted to various styles of label printers and label media. The particular examples herein show single sided, single ply label printing media. However, dual side printing is easily implemented and may be especially useful when coupons are pre-printed. Moreover, coupons may be printed on multi-ply paper such that the pre-printed coupons appear underneath the product identification label. These and similar modifications are within the scope of the present invention.

The present invention is particularly useful in affecting in-store consumer behavior. The present invention recognizes that incentives provided at the point of customer selection, yet before the customer reaches the point of sale to consummate the purchase, provide a unique method to monitor and affect in-store customer behavior. Based on the product selection, the terminal in the specialty department queries an incentive database to identify incentives that are associated with the customer's product selection. In many cases, there may be a pool of incentives that are available, and processes implemented in the terminal select one or more incentives from the pool. The selected incentives are implemented as printed coupons. Preferably, the coupons are printed integrally with pre-existing label printing processes so that little overhead is incurred to provide the coupons.

The incentive database comprises information about available manufacturer or retailer sponsored incentives and implements an association between products and incentives. A given product may be associated with one or more incentives. Similarly, a given incentive may be associated with one or more products.

The incentive database may be maintained locally in each terminal, but is preferably implemented in a shared resource such as server 102. In particular embodiments, a fixed number (e.g., three) of coupons are printed for any product selection. Where more than the fixed number of incentives are associated with the product selection, a round-robin or random process may be used to identify the fixed number of incentives that will be printed as coupons. The coupons may be pre-printed on the tape used to print the label, in which case the selection of which coupons are associated with a particular label is pre-established. Alternatively, the present invention may be implemented by mixing pre-established or pre-printed coupons with dynamically generated coupons. For example, the label tape may be pre-printed with coupons for a particular product type, and the discount amount filled in during the label printing process based on the particular customer selection.

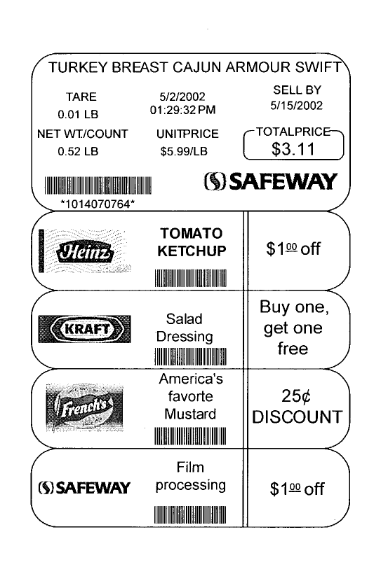

FIG. 2 shows an exemplary label coupon 200 in accordance with the present invention. A label coupon 200 includes a product selection information portion 201 that contains information relevant to the particular customer's selections. For example, this information may include a product name, brand name, weight, quantity, unit price, shelf life information, and the like. Additionally, each label comprises one or more label coupons implementing incentive offers for selected products. The selected products are preferably based upon the customer selected product, and are preferably associated with complementary goods and/or services. The coupons may implement incentives for manufacture goods and/or services, or private label (i.e., house brand) goods and/or services.

The selection of which goods and/or services are complementary to a given customer product selection is left to the manufacturer, retailer, and marketing organizations. The association of a given incentive to a given product may change at any time. Moreover, other criteria may be taken into account in selecting a particular set of incentives to implement (i.e., print) for a particular product selection instance. For example, customer shopping history, previously selected products, customer demographics, or other information may be taken into account in the selection of incentives from the pool of available incentives associated with a particular customer product selection. Also, the incentives may be based on a variety of criteria related to the particular customer selection. For example, a different set of coupons may be printed for a customer selecting ten pounds of hamburger patties (suggesting a large picnic) than would be provided to a customer selecting one pound of hamburger patties (suggesting a simple family meal).

In one embodiment, each coupon is printed with a barcode indicator that can be scanned at the register 105 for redemption. Coupons that are used will be matched against purchased items in a conventional manner. Coupons that are not used can be logged for analysis to determine in real time whether a particular incentive is having a desired affect on customer behavior.

Coupons may be implemented as conventional coupons with a specified expiration date, or may be specified to expire upon this shopping session. Allowing coupons to extend to subsequent shopping sessions encourages store loyalty. Providing for immediate coupon expiration encourages specific customer behavior, and allows resources allocated to the coupon to be reallocated to existing shoppers.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed. For example, coupons are now provided in printed form, but the present invention is readily extended to non-paper coupon types such as might be implemented with RF ID tags or the like by programming label coupons into the label tag that accompanies the product.

We claim:

1. A system for generating a printable discount coupon in a retail store comprising:
a plurality of terminals at specialty department locations, each terminal including a label printing mechanism, and having an interface for receiving information about a customer's product selection;
an incentive datastore having data describing available incentives, the available incentives being associated with particular product selections; and
mechanisms within the terminals responsive to received information about a customer's product selection to access the incentive datastore to obtain at least one incentive description associated with the customer's product selection and print a coupon implementing the incentive using the label printing mechanism.

2. The system of claim 1 wherein the coupon is printed integrally with a product identification/quantity/pricing label otherwise used by the specialty department to indicate specific information about the customer's selected product.

3. The system of claim 1 wherein the coupon implements an incentive to buy a product and/or service that complementary to the customer's product selection.

4. The system of claim 1 wherein the selected incentive comprises an incentive to buy a product and/or service that is different from the customer's product selection.

5. The system of claim 1 wherein the coupon is printed after a customer has selected a particular, specific product from the specialty department location and before the customer has completed a purchase transaction.

6. The system of claim 1 further comprising:
a communication network coupled to the plurality of terminals;
a central controller coupled to the communication network comprising data processing mechanisms and the incentive database.

7. A locally printable product label comprising:
a product information portion having information specifically relevant to a particular consumer selection printed thereon; and
a coupon having an incentive offer that is specifically relevant to the particular consumer selection.

8. The product label of claim 7 wherein the product information and coupon are printed after product selection but before point of sale.

9. A terminal for use at a specialty department in a retail environment, the terminal comprising:
a label printing mechanism;
an interface for receiving information about a customer's product selection; and
coupon processes operable at the time of a customer's product selection that are responsive to received information about a customer's product selection to identify at least one incentive description associated with the customer's product selection and print a coupon implementing the identified incentive using the label printing mechanism.

10. The terminal of claim 9 further comprising an incentive datastore stored within the terminal, the incentive datastore containing data describing available incentives, the available incentives being associated with particular product selections.

11. The terminal of claim 9 further comprising an interface for coupling to an external incentive database, the incentive datastore containing data describing available incentives, the available incentives being associated with particular product selections.

12. The terminal of claim 9 further comprising department-specific mechanisms for performing department specific functions independent of the coupon processes.

13. Software for generating a coupon in response to a consumer product selection comprising:
product selection processes for identifying information about a specific customer product selection, the information selected from the group consisting of product type, name, brand, quantity, grade, price per unit, UPC, weight, source, and shelf life;
coupon selection processes for identifying one or more coupon offers associated with the information identified by the product selection processes; and
printing processes for printing a product label comprising both information about the specific product selection and a printed representation of the coupon offer.

14. A method for implementing a marketing incentive program comprising:
within a retail environment, after a product selection has been made but before a product purchase has been completed, providing an incentive coupon based upon the product selection but for goods and/or services different from that of the product selection.

15. The method of claim 14 further comprising:
charging one or more manufacturers an amount based on the number of coupons provided;
providing the retailer a first share of revenue generated by charging the manufactures, while providing a marketing entity that provides the incentive coupon a second share of the new revenue.

16. The method of claim 14 comprising:
charging one or more manufacturers an amount based on the number of coupons provided;
retaining all of the revenue generated by charging the one or more manufacturers in a marketing entity that provides the incentive coupon; and
subsidizing label costs incurred by the retailer using revenue retained by the marketing entity.
